(19) United States
(12) Patent Application Publication
(10) Pub. No.: US 2024/0199328 A1
(43) Pub. Date: Jun. 20, 2024

(54) STORAGE FACILITY WITH AISLES THAT CAN BE DRIVEN ALONG

(71) Applicant: NEDCON B.V., Doetinchem (NL)

(72) Inventor: Jan-Willem FREDERIKS, Doetinchem (NL)

(73) Assignee: NEDCON B.V., Doetinchem (NL)

(21) Appl. No.: 18/554,506

(22) PCT Filed: Apr. 12, 2022
(86) PCT No.: PCT/EP2022/059789

§ 371 Date: Oct. 9, 2023

(30) Foreign Application Priority Data
Apr. 27, 2021 (DE) 10 2021 110 715.6

(51) Int. Cl. B65G 1/04; B65G 41/00; F16M 11/42

(52) U.S. Cl. CPC B65G 1/0492; B65G 41/006; F16M 11/425

(57) ABSTRACT

A storage facility has a base frame composed of vertical supports and horizontal crosspieces. A carrier can be driven on two rails in an aisle through the base frame for introducing and removing goods. Each rail has a horizontal limb forming a running surface for the carrier, and a vertical limb. The rail, in a fastening region extending over a partial length thereof, is fastened by fastening elements to one of the supports and/or crosspieces. The vertical limb, in the fastening region, is provided with holes through which the fastening elements lead. The vertical limb, in the fastening region but outside the holes, is provided with at least one structural weakening in the form of an opening. The latter extends like a slit substantially in the longitudinal direction of the rail and at a height closer to the horizontal limb than to the upper edge of the vertical limb.

### CROSS-REFERENCE TO RELATED APPLICATION

This application is a national stage application, filed under 35 U.S.C. § 371, of International Patent Application PCT/EP2022/059789, filed on Apr. 12, 2022, which claims the benefit of German Patent Application DE 10 2021 110 715.6, filed on Apr. 27, 2021.

### BACKGROUND

Storage facilities, as are known from DE 10 2019 104 372 A1, for example, are stores for piece goods, in which the loading units, for example goods or pallets loaded with goods, are arranged one behind another in individual gangways, or they are stored on both sides of an aisle. For the storage or removal or else relocation of the goods, a self-propelled distribution vehicle, often referred to as a shuttle or carrier, is used. This vehicle is designed to drive under the goods or load carriers, to then raise them, and, in this raised state, to transport them to a different position in the storage facility. Distribution vehicles of this type have, in particular, means for fully automatically raising the goods or the load carriers supporting the goods, for pulling them out of the laterally arranged storage positions into the aisle, and then for moving them within and along the aisle. The rails on which the rollers of the distribution vehicles run are often segmented because of their considerable length, i.e. are composed of successive rail segments in the form of respective profiles. The profiles are bolted to the base frame of the storage facility, which primarily consists of vertical supports and horizontal crosspieces.

Long-term tests have revealed that cracks starting from the holes are formed under pulse loads in the fastening region between the rail and the support and/or the crosspiece, more precisely at the holes through which the rail has been fastened at least indirectly to the support and/or crosspieces, the cracks expanding over time and then passing through the vertical limb of the rail. This leads to a weakening of the rail. The formation of cracks could be counteracted by increasing the material thickness of the rail. However, this leads to an increase in material requirements and thus in material costs.

The critical pulse loads are generated especially where the carrier is transferred from a transport device, e.g. an elevator, onto the rail. Often, the running surfaces of the rails and the rails on the elevator are not aligned with one another, but rather are at a height difference from one another. When moving the carrier, the carrier may have to overcome the height difference with its rollers. Due to the fast-moving and usually heavily loaded carriers, even small height differences trigger pulse loads when the carrier is transferred to the closest fastening region of the rail.

### SUMMARY

The disclosure relates to a storage facility with a base frame consisting of vertical supports and horizontal crosspieces and with at least one aisle leading through the base frame for the storage and removal of goods by means of a carrier which is movable on two rails in the aisle, wherein the respective rail consists of a horizontal limb, which forms a running surface for the carrier, and at least one vertical limb, wherein the rail, in a fastening region extending only over a partial length of the rail, is fastened at least indirectly by means of fastening elements, preferably screw connections, to one of the supports and/or crosspieces, and wherein the vertical limb, in the fastening region, is provided with holes through which the fastening elements lead.

It is the object of the disclosure to develop the known storage facility in such a way that, even during relatively long-term operation, no formation of cracks occurs on the rail in the connection region between the rails and the supports or crosspieces.

To achieve the object, it is proposed that the vertical limb of the rail, in the fastening region but outside the holes, is provided with at least one structural weakening in the form of an opening, which extends in the manner of a slot substantially in the longitudinal direction of the rail and is arranged at a height closer to the horizontal limb than to the upper edge of the vertical limb.

Preferably, the holes serving for fastening purposes are arranged at partly different heights, wherein the structural weakening is arranged below the deepest hole through which one of the fastening elements leads.

Preferably, the structural weakening, through which no fastening element leads, is arranged between the holes through which fastening elements lead and which are closest to the ends of the fastening region in the longitudinal direction of the rail.

Owing to the structural weakening even below the lowermost holes serving for connecting the rail to the base frame, increased flexibility of the rail in the connection region is achieved. In particular in the case of pulse-like loads on the rail, e.g. when the carrier is placed on the rail, this increased flexibility in the connection region avoids the formation of cracks starting from the holes in the rail serving for fastening purposes. The structural weakening means that the pulse-like load is absorbed in an uncritical deformation of the region around the structural weakening, with the energy stored in the elastic deformation subsequently being released again in a complete reverse deformation.

In order to prevent any tearing of the slot-like opening even during very long-term operation, the structural weakening preferably has a largely rounded contour. The design of the structural weakening to be as round or rounded as possible ensures a favorable force flux and excludes a shape-related notch effect. It is conceivable to produce the opening in a punching process, with a slight bulge being formed on that side of the rail which faces in the punching direction, said bulge further improving the structural integrity of the opening in relation to the formation of cracks.

Preferably, the structural weakening consists of two mutually spaced-apart, circular recesses, wherein the recesses are connected to each other by an arcuate slot. In other words, the structural weakening in the form of an opening is an arched horizontal slot with respectively widened ends, even below the lowermost hole of the rail. This design ensures that, in the case of a pulse-like load of the rail, the load is not output directly from the rail via the fastening elements to the crosspieces and/or supports, but also some of the load is absorbed in an elastic deformation of the region between the lowest hole and the opening located spaced apart therebelow.

For connecting the rail to the support and/or crosspiece, the rail with its fastening region is preferably arranged on a bracket via the fastening elements, wherein the bracket, for its part, is fastened to one of the supports and/or crosspieces. The bracket lies at least against the vertical fastening region of the rail and is connected to the rail via screw connections. At another end, the bracket is fastened, by contrast, to a support or a crosspiece, with a screw or a welded connection also being conceivable here. However, other types of connections, such as rivets, for example, are generally also possible.

To support the running surface on the horizontal limb of the rail, the storage facility preferably has a support bracket consisting of a vertical and a horizontal limb, wherein the limbs extend parallel to the limbs of the rail only over a partial length of the rail, wherein the vertical limb of the support bracket is fastened to the vertical limb of the rail via further fastening elements, and the horizontal limb of the support bracket engages under the horizontal limb of the rail.

The support bracket is designed to support the rail in the connection region toward the support and/or toward the crosspiece. For this purpose, the horizontal limb of the rail preferably rests on the horizontal limb of the support bracket. As a result, loads acting on the running surface of the rail are additionally absorbed by the horizontal limb of the rail. It is also conceivable that the horizontal sections of the support bracket and the rail are formed without direct contact with each other, but the running surface is lowered by a carrier being driven along it and comes to rest on the horizontal section of the support bracket before plastic deformation of the running surface with respect to the vertical limb of the rail occurs.

Preferably, the support bracket has, in its vertical limb, a clearance which allows at least indirect fastening of the fastening region of the rail to a support or/and to a crosspiece and without the interposition of the support bracket. In order to avoid a lateral displacement of the rail, triggered by the support bracket, between the rail and the bracket in the transverse direction to the aisle, the support bracket is provided with the clearance. The clearance allows the bracket to be fastened directly to the fastening region such that the support bracket at least partially encircles the bracket. Consequently, the support brackets are not fastened to the brackets and can even be contactless with respect thereto.

Furthermore, however, it is also conceivable that the support brackets, because of their shaping, lie against the brackets or are connected to the brackets in a form-fitting or integrally bonded manner.

In principle, the support brackets are designed to be arranged on the fastening regions of the rails, with preferably a plurality of the fastening regions being distributed at a distance of 1 m to 1.5 m from one another over the rail. In principle, however, correspondingly adapted, larger and/or smaller distances between the fastening regions are also conceivable. However, since the fastening regions in the unloading and loading region of a rail are most heavily loaded, it is also conceivable to arrange the support brackets only in this region.

Preferably, a region which widens in relation to the aisle is located on the vertical and the horizontal limb of the support bracket, wherein the widened region of the support bracket extends beyond the end of the rail and is designed as an insertion aid when placing the carrier onto the rail. This measure at the support bracket ensures that no special rails with similar features for the unloading and loading region need to be formed and it is thus possible only to use rails of one embodiment. On the other hand, the support brackets with an expanded region can also be used in fastening regions that do not represent the unloading and loading region of a rail.

Preferably, the rail has a further horizontal limb, which is connected to the upper edge of the vertical limb and is formed facing away from the aisle or facing toward the aisle. Furthermore, the rail preferably has a further vertical limb, which is connected, facing downward or upward, to that end of the horizontal limb which faces toward the aisle. The other limbs of the rail ensure a higher stiffening and an associated increase in the load-bearing capacity.

Owing to the stiffened form of the rail and the support of the running surface by the support bracket, the rail preferably has a material thickness of only 2 mm to 4 mm. However, larger and/or smaller material thicknesses are also conceivable, depending on the rail length and the predicted load. By supporting the rail in the connection region and by its generally stiffened form, it is thus possible to reduce the material thickness of the rail in comparison to the rails from the prior art and to save material costs during production.

Further measures will be explained in more detail below together with the description of a preferred exemplary embodiment of the invention with reference to the figures.

### BRIEF DESCRIPTION OF THE DRAWINGS

FIG. 1 shows a perspective view of a support with a crosspiece and a rail arranged thereon;

FIG. 2 shows a rear view of a crosspiece with a rail arranged thereon;

FIG. 3 shows a perspective view of the rail with a structural weakening; and

FIG. 4 shows a perspective view of a support bracket.

### DETAILED DESCRIPTION

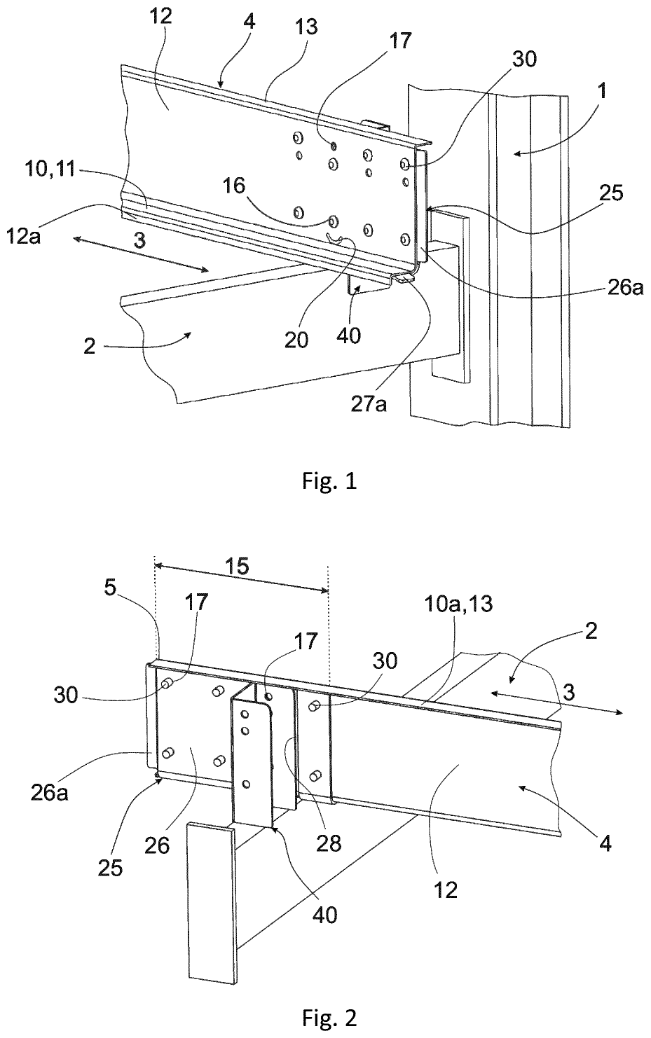

FIG. 1 shows parts of a base frame as components of a storage facility, namely a vertical support 1 and a horizontal crosspiece 2 fastened thereto. Transversely to the crosspiece 2, a rail 4 is fastened on the top side of the crosspiece 2, said rail forming an aisle 3 between itself and a parallel second rail, not illustrated. The aisle 3 is designed for the storage and removal of goods by means of a carrier which is movable along the aisle 3 on the two rails 4. The carrier is a motor-operated transport vehicle which is movable on at least four rollers and by its own power on the rails 4 within the storage facility. For this purpose, the carrier consists, for example, of a base body, which serves both for supporting the goods to be transported and as a store for the rollers. A multiplicity of carriers which are controlled by software of a central computer are present in corresponding storage facilities.

The respective rail 4 consists in one piece of a horizontal limb 10, the top side of which forms the running surface 11 for the carrier, and a vertical limb 12, which represents the lateral running surface boundary for the carrier. The rail 4 consists of a rectangular, cold-formed steel sheet with a material thickness of 2 mm to 4 mm.

According to FIG. 2, the rail 4 has a fastening region 15, which extends only over a partial length of the rail 4, on its vertical limb 12. The rail 4 is arranged on a bracket 40 only by the fastening region 15. In principle, although not shown, a plurality of the fastening regions 15 are distributed over the rail 4. The vertical limb 12 of the rail 4 and the bracket 20 are provided in the fastening region 15 with mutually aligned holes 17 through which the rail 4 is fastened to the bracket 40 by means of fastening elements 16 in the form of screw connections. The bracket 40 is, for example, fastened by its underside to the crosspiece 2.

Furthermore, a support bracket 25 consisting of a vertical and a horizontal limb 26, 27 is fastened to the rear side of the rail 4. The limbs 26, 27 extend only over a partial length of the rail 4 and are formed parallel to the limbs 10, 12 of the rail 4. The vertical limb 26 of the support bracket 25 is fastened to the vertical limb 12 of the rail 4, with the horizontal limb 27 of the support bracket 25 engaging under the horizontal limb 10 of the rail 4. To connect the support bracket 25 to the rail 4, the rail 4 is formed with further holes 17, which are aligned with holes 17 in the support bracket 25. In order to produce a form-fitting connection between the rail 4 and the support bracket 25, further fastening elements 30 in the form of screw joints or rivets are arranged in the holes 17 of the rail 4 and of the support bracket 25.

In addition to the supporting effect of the support bracket 25 for the running surface 11 of the rail 4, an obliquely expanding region 26a, 27a is located on the vertical and the horizontal limb 26, 27 of the support bracket 25. The expanded region is formed in that the vertical limb 26 otherwise running parallel to the vertical limb 12 of the rail 4 widens facing away from the aisle 3 in a partial region. This is also the case with the horizontal limb 27 of the support bracket 25, which widens away downward.

The widened region 26a, 27a of the support bracket 25 is designed in such a manner that it reaches beyond the end of the rail 4 and thus serves as an insertion aid when the carrier is first driven onto the rail 4.

In order to avoid a lateral displacement of the rail 4, triggered by the support bracket 25 between the rail 4 and the bracket 40 in the transverse direction to the aisle 3, the support bracket 25, according to FIGS. 2 and 4, is provided with a clearance 28, which allows the bracket 40 to be directly fastened to the fastening region 15 of the rail 4. Consequently, the support bracket 25 is designed such that it frames the bracket 40 at least on three sides. Consequently, the support bracket 25 is not directly connected to the bracket 40.

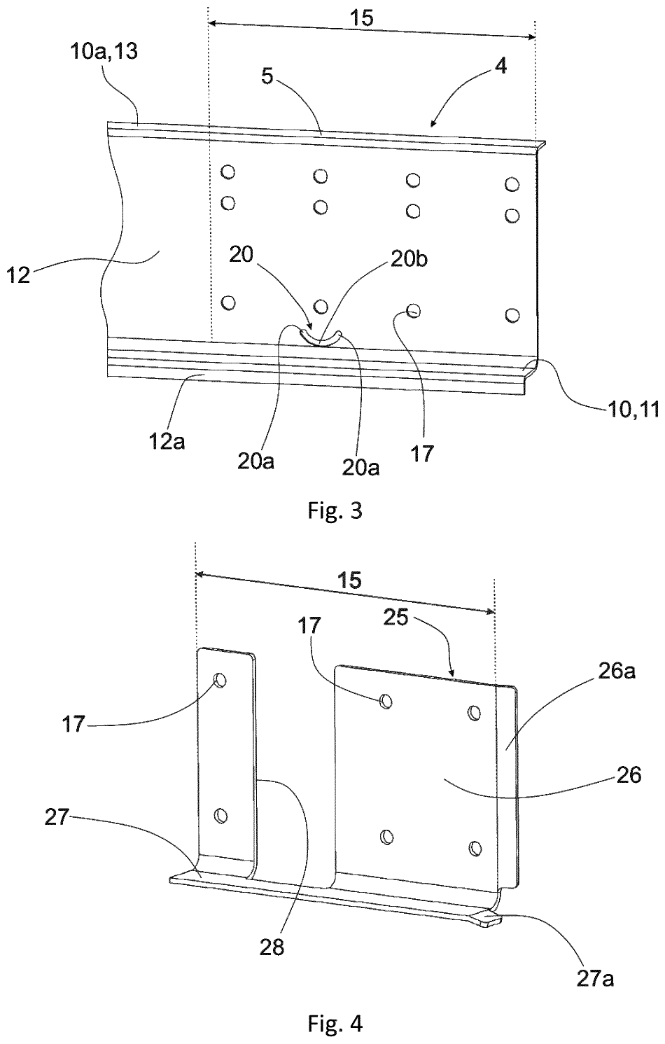

FIG. 3 shows a perspective view of the rail 4 with a structural weakening 20 in the vertical limb 12 of the rail. The structural weakening 20, through which no fastening element whatsoever passes and which is therefore open, is at a height closer to the horizontal limb 10 than to the upper edge 13 of the vertical limb 12 and is preferably still arranged below the deepest hole 17 in the fastening region 15.

In particular, the structural weakening 20 is arranged between the holes 17 which are closest to the ends of the fastening region 15 in the longitudinal direction of the rail 4. This arrangement of the structural weakening 20 has the effect that the holes 17 closest to the ends of the fastening region 15 are designed exclusively to be connected to the support bracket 25 such that the support bracket 25 particularly stiffens those sections of the fastening region 15 which surround the structural weakening 20.

The structural weakening 20 is formed from a slot-shaped and predominantly horizontally extending opening 20 of a rounded contour. More specifically, the opening 20 consists of two horizontally spaced-apart recesses 20a, wherein the recesses 20a are connected to each other by an arcuate slot 20b.

An embodiment, in which the recesses 20a have a larger diameter than the slot 20b connecting them has a cross section, is not shown. The enlargement at the recesses 20a ensures that the notch effect is further reduced.

It is shown in FIG. 3 that the rail 4 has a further horizontal limb 10a, which is connected to the upper edge 13 of the vertical limb 12 and is designed facing away from the aisle 3. With the same objective, of further stiffening the rail, the latter also has a further vertical limb 12a, which is connected, facing downward, to that end of the horizontal limb 10 which faces toward the aisle 3.

### LIST OF REFERENCE SIGNS

1 support
2 crosspieces
3 aisle
4 rail
5 rail end
10 horizontal limb
10a horizontal limb
11 running surface
12 vertical limb
12a vertical limb
13 upper edge
15 fastening region
16 fastening element, screw
17 hole
20 structural weakening/opening
20a recess
20b slot
25 support bracket
26 vertical limb
26a expanded region
27 horizontal limb
27a expanded region
28 clearance
30 fastening element, screw
40 bracket

1-11. (canceled)

12. A storage facility, comprising:
a base frame made of vertical supports (1) and horizontal crosspieces (2);
an aisle (3) leading through the base frame;
a carrier for storing and removing goods, the carrier being movable on two rails (4) that are arranged in the aisle (3),
wherein each of the two rails (4) comprises
a horizontal limb (10) that forms a running surface (11) for the carrier, and
at least one vertical limb (12), and
wherein each of the two rails (4), in a fastening region (15) extending only over a partial length of the respective rail (4), is fastened by fastening elements (16) to one of the vertical supports (1) and/or horizontal crosspieces (2), and
wherein the vertical limb (12), in the fastening region (15), is provided with holes (17) through which the fastening elements (16) lead, and
wherein the vertical limb (12), in the fastening region (15) but outside the holes (17), is provided with at least one structural weakening (20) in form of an opening that extends as a slot substantially in a longitudinal direction of the rail (4) and is arranged at a height closer to the horizontal limb (10) than to an upper edge (13) of the vertical limb (12).

13. The storage facility as claimed in claim 12,
wherein the fastening elements (16) are screw connections.

14. The storage facility as claimed in claim 12,
wherein the holes (17) are arranged at partly different heights, and
wherein the structural weakening (20) is arranged below a deepest of the holes (17) through which one of the fastening elements (16) leads.

15. The storage facility as claimed in claim 12,
wherein the structural weakening (20) is arranged between the holes (17) which are closest to ends of the fastening region (15) in the longitudinal direction of the rail (4).

16. The storage facility as claimed in claim 12,
further comprising a support bracket (25) including a vertical limb (26) and a horizontal limb (27),
wherein the vertical limb (26) and a horizontal limb (27) of the support bracket (25) extend parallel to the vertical limbs (12) and the horizontal limb (10) of the rail (4) only over a partial length of the rail (4),
wherein the vertical limb (26) of the support bracket (25) is fastened to the vertical limb (12) of the rail (4) via further fastening elements (30), and
wherein the horizontal limb (27) of the support bracket (25) engages under the horizontal limb (10) of the rail (4).

17. The storage facility as claimed in claim 16,
wherein the support bracket (25) has, in its vertical limb (26), a clearance (28) which allows at least indirect fastening of the fastening region (15) of the rail (4) to a support (1) or/and to a crosspiece (2).

18. The storage facility as claimed in claim 16,
wherein a widened region (26a, 27a) which widens in relation to the aisle (3) is located on the vertical limb (26) and the horizontal limb (27) of the support bracket (25),
wherein the widened region (26a, 27a) of the support bracket (25) extends beyond an end (4a) of the rail (3) and is designed as an insertion aid when placing the carrier onto the rail (4).

19. The storage facility as claimed in claim 12,
wherein the rail (4) has a further horizontal limb (10a), which is connected to the upper edge (13) of the vertical limb (12) and is formed facing away from the aisle (3) or facing toward the aisle (3).

20. The storage facility as claimed in claim 12,
wherein the rail (4) has a further vertical limb (12a), which is connected, facing downward or upward, to that end of the horizontal limb (10) which faces toward the aisle (3).

21. The storage facility as claimed in claim 12,
wherein the rail (4) with its fastening region (15) is arranged on a bracket (40) via the fastening elements (16), wherein the bracket (40) is fastened to one of the vertical supports (1) and/or horizontal crosspieces (2).

22. The storage facility as claimed in claim 12,
wherein the structural weakening (20) has a largely rounded contour.

23. The storage facility as claimed in claim 22,
wherein the structural weakening (20) consists of two mutually spaced-apart, circular recesses (20a), and
wherein the circular recesses (20a) are connected to each other by an arcuate slot (20b).
